(19) United States
(12) Patent Application Publication
(10) Pub. No.: US 2018/0100506 A1
(43) Pub. Date: Apr. 12, 2018

(54) SUPERCHARGER HAVING ROTOR WITH PRESS-FIT STUB SHAFTS

(71) Applicant: Eaton Corporation, Cleveland, OH (US)

(72) Inventors: Andrew Meyers, Marshall, MI (US); Kenneth Rienas, Howell, MI (US); Daniel Ouwenga, Portage, MI (US)

(73) Assignee: Eaton Corporation, Cleveland, OH (US)

(21) Appl. No.: 15/837,198

(22) Filed: Dec. 11, 2017

Related U.S. Application Data
(63) Continuation of application No. PCT/US2016/036817, filed on Jun. 10, 2016.
(60) Provisional application No. 62/174,125, filed on Jun. 11, 2015.
(60) Provisional application No. 62/174,513, filed on Jun. 11, 2015.

(51) Int. Cl. F04C 29/00; F02B 33/38; F02B 39/04; F04C 18/12

(52) U.S. Cl. CPC F04C 29/0078; F02B 33/38; F02B 39/04; F04C 18/126; F04C 2270/23; F04C 2240/20; F04C 2240/603; F04C 2240/50; F04C 29/0028

(57) ABSTRACT

A supercharger constructed in accordance to one example of the present disclosure includes a housing, a first rotor, a second rotor and a rotor shaft assembly. The first and second rotors are received in cylindrical overlapping chambers of the housing. The first rotor has a central longitudinal passage. The rotor shaft assembly rotatably supports the first rotor and includes a first rotor shaft and a separate and distinct second rotor shaft. The first and second rotor shafts are press-fit into the central passage defined in the first rotor.

### CROSS-REFERENCE TO RELATED APPLICATIONS

This application is a continuation of International Application No. PCT/US2016/036817 filed Jun. 10, 2016, which claims the benefit of U.S. Patent Application No. 62/174,125 filed on Jun. 11, 2015; and U.S. Patent Application No. 62/174,513 filed on Jun. 11, 2015. The disclosures of the above applications are incorporated herein by reference.

### FIELD

The present disclosure relates generally to superchargers and more particularly to a supercharger that incorporates stub shafts that are press-fit into the rotor shaft.

### BACKGROUND

Rotary blowers of the type to which the present disclosure relates are referred to as “superchargers” because they effectively super charge the intake of the engine. One supercharger configuration is generally referred to as a Roots-type blower that transfers volumes of air from an inlet port to an outlet port. A Roots-type blower includes a pair of rotors which must be timed in relationship to each other, and therefore, can be driven by meshed timing gears. Typically, a pulley and belt arrangement for a Roots blower supercharger is sized such that, at any given engine speed, the amount of air being transferred into the intake manifold is greater than the instantaneous displacement of the engine, thus increasing the air pressure within the intake manifold and increasing the power density of the engine.

In one traditional supercharger configuration, each rotor is press-fit onto a corresponding rotor shaft during an assembly process. The press-fit creates a first press fit on a front end of the rotor and a second press fit on a rear end of the rotor. In some examples, Roots-type blowers can experience “inching” that is caused by the interaction of the front and rear press fits. Rotor inching occurs when the rotor moves axially on the shaft due to thermal loadings experienced at the interface between the rotor and the rotor shaft. Inching can occur if the rotor shaft grows axially, but the rear section of the rotor shaft press-fit has a higher clamp force than the front rotor after the rotor begins to cool. This can result in the rear press location remaining fixed to the rotor shaft, while the front area of the rotor slides along the rotor shaft during rotor thermal contraction. This results in a net movement of the rotor toward the rear section of the rotor shaft.

Another unfavorable characteristic that may be experienced by a rotor and its rotor shaft is rotor “pop”. Rotor “pop” can be caused by the sudden release of residual stresses inside the rotor caused by the interaction of the front and rear press fits on the rotor and rotor shaft interface. The phenomenon often creates an audible “pop” noise and can result in a rotor physically moving. The rotor “pop” often occurs during the curing process of the rotor coating, where the rotors undergo a heat treatment. Damage can occur to the rotor coating if “popping” occurs prior to the coating being fully cured on the rotor surface. A rotor that has “popped” before the rotor coating is cured can require the coating to be removed and the rotor to be recoated. It would be desirable to reduce or eliminate the occurrence of “inching” and rotor “pop”.

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

A supercharger constructed in accordance to one example of the present disclosure includes a housing, a first rotor, a second rotor and a rotor shaft assembly. The first and second rotors are received in cylindrical overlapping chambers of the housing. The first rotor has a central longitudinal passage. The rotor shaft assembly rotatably supports the first rotor and includes a first rotor shaft and a separate and distinct second rotor shaft. The first and second rotor shafts are press-fit into the central passage defined in the first rotor.

According to additional features, the first and second rotor shafts can be stub shafts. The first and second rotor shafts can be offset from each other in the central longitudinal passage. According to other features, the supercharger can include a front bearing disposed in the housing that supports the first rotor shaft. A second bearing can be disposed in the housing that supports the second rotor shaft. The first rotor shaft can include a first insertion portion that is received by the central longitudinal passage, an intermediate seal engaging portion configured to be engaged by a seal, a front baring engaging portion that is supported by the front bearing, and an isolator engaging portion that is configured to engage a timing gear.

In other features, the second rotor shaft can include a second insertion portion that is received by the central longitudinal passage and a rear bearing engaging portion that is supported by the rear bearing. The second rotor shaft includes a second radial collar that is dimensioned to be nestingly received at a counter bore defined in the first rotor. The counterbore can have a first inner diameter. The central longitudinal passage can have a second inner diameter. The first inner diameter can be greater than the second inner diameter. The first insertion portion can include a straight knurl feature.

According to other features, the supercharger can further comprise a vent configuration collectively formed by a first passage, a second passage and a third passage. The first passage can be defined in the first rotor shaft. The second passage can be defined in the second rotor shaft. The third passage can be defined through the housing. Air can be routed through the vent configuration toward an inlet of the supercharger. A front rotor shaft seal can sealingly engage the first rotor shaft. The first passage can connect an outer surface of the rotor shaft with an internal bore of the first rotor shaft. The second passage can connect an outer surface of the second rotor shaft with an internal bore of the second rotor shaft.

A supercharger constructed in accordance to additional features of the present disclosure can include a housing, a first rotor and a second rotor, and a rotor shaft assembly. The first and second rotors can be received in cylindrical overlapping chambers of the housing. The first rotor can define a central longitudinal passage. The rotor shaft assembly can support the first rotor. A first rotor shaft can have a first insertion portion that is received by the central longitudinal passage, and an intermediate seal engaging portion configured to be engaged by a seal. A front bearing engaging portion can be supported by the front bearing. An isolator engaging portion can be configured to engage a timing gear. A second rotor shaft, separate and distinct from the first rotor shaft, can have a second insertion portion that is received by the central longitudinal passage and a rear bearing engaging portion that is supported by the rear bearing.

In other features, the first and second rotor shafts can be press-fit into the central longitudinal passage defined in the first rotor. The counterbore can have a first inner diameter and the central longitudinal passage can have a second inner diameter. The first inner diameter can be greater than the second inner diameter.

According to other features, the supercharger can further comprise a vent configuration collectively formed by a first passage, a second passage and a third passage. The first passage can be defined in the first rotor shaft. The second passage can be defined in the second rotor shaft. The third passage can be defined through the housing. Air can be routed through the vent configuration toward an inlet of the supercharger. A front rotor shaft seal can sealingly engage the first rotor shaft. The first passage can connect an outer surface of the rotor shaft with an internal bore of the first rotor shaft. The second passage can connect an outer surface of the second rotor shaft with an internal bore of the second rotor shaft.

### BRIEF DESCRIPTION OF THE DRAWINGS

The present disclosure will become more fully understood from the detailed description and the accompanying drawings, wherein:

FIG. 1 is a schematic illustration of an intake manifold assembly having a positive displacement blower or supercharger constructed in accordance to one example of the present disclosure;

FIG. 2 is a cross-sectional view of a supercharger rotor having press-fit stub shafts in accordance to one example of the present disclosure; and

FIG. 3 is a cross-sectional view of the supercharger incorporating the press-fit stub shafts shown in FIG. 2 and further a high pressure seal vent configuration.

### DETAILED DESCRIPTION

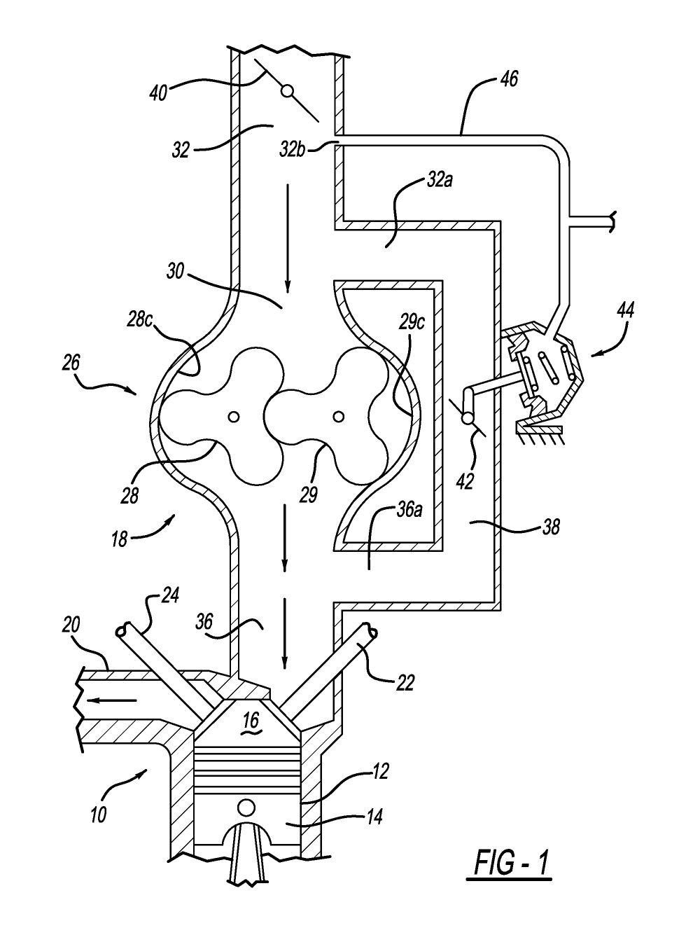

With initial reference to FIG. 1, a schematic illustration of an exemplary intake manifold assembly, including a Roots blower supercharger and bypass valve arrangement is shown. An engine 10 can include a plurality of cylinders 12, and a reciprocating piston 14 disposed within each cylinder and defining an expandable combustion chamber 16. The engine 10 can include intake and exhaust manifold assemblies 18 and 20, respectively, for directing combustion air to and from the combustion chamber 16, by way of intake and exhaust valves 22 and 24, respectively.

The intake manifold assembly 18 can include a positive displacement rotary blower 26, or supercharger of the Roots type. Further description of the rotary blower 26 may be found in commonly owned U.S. Pat. Nos. 5,078,583 and 5,893,355, which are expressly incorporated herein by reference. The blower 26 includes a pair of rotors 28 and 29, each of which includes a plurality of meshed lobes. The rotors 28 and 29 are disposed in a pair of parallel, transversely overlapping cylindrical chambers 28c and 29c, respectively. The rotors 28 and 29 may be driven mechanically by engine crankshaft torque transmitted thereto in a known manner, such as by a drive belt (not specifically shown). The mechanical drive rotates the blower rotors 28 and 29 at a fixed ratio, relative to crankshaft speed, such that the displacement of the blower 26 is greater than the engine displacement, thereby boosting or supercharging the air flowing to the combustion chambers 16.

The supercharger 26 can include an inlet port 30 which receives air or air-fuel mixture from an inlet duct or passage 32, and further includes a discharge or outlet port 34, directing the charged air to the intake valves 22 by means of a duct 36. The inlet duct 32 and the discharge duct 36 are interconnected by means of a bypass passage, shown schematically at reference 38. If the engine 10 is of the Otto cycle type, a throttle valve 40 can control air or air-fuel mixture flowing into the intake duct 32 from a source, such as ambient or atmospheric air, in a well know manner. Alternatively, the throttle valve 40 may be disposed downstream of the supercharger 26.

A bypass valve 42 is disposed within the bypass passage 38. The bypass valve 42 can be moved between an open position and a closed position by means of an actuator assembly 44. The actuator assembly 44 can be responsive to fluid pressure in the inlet duct 32 by a vacuum line 46. The actuator assembly 44 is operative to control the supercharging pressure in the discharge duct 36 as a function of engine power demand. When the bypass valve 42 is in the fully open position, air pressure in the duct 36 is relatively low, but when the bypass valve 42 is fully closed, the air pressure in the duct 36 is relatively high. Typically, the actuator assembly 44 controls the position of the bypass valve 42 by means of a suitable linkage. The bypass valve 42 shown and described herein is merely exemplary and other configurations are contemplated. In this regard, a modular (integral) bypass, an electronically operated bypass, or no bypass may be used.

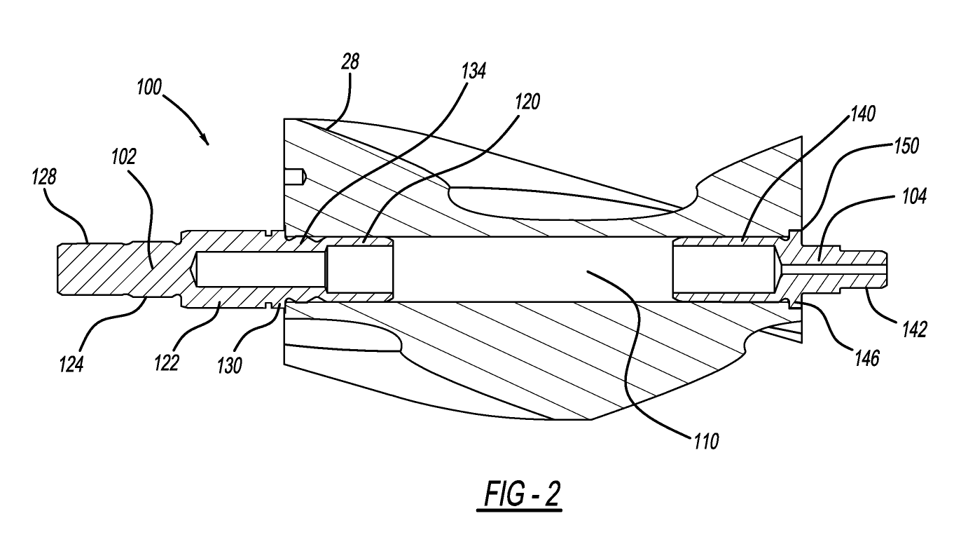

With particular reference now to FIG. 2, additional features of the supercharger 26 will be described in greater detail. The supercharger 26 according to the present disclosure includes a rotor shaft assembly 100 comprising a first (front) rotor shaft 102 and a second (rear) rotor shaft 104. The first and second rotor shafts 102 and 104 are stub shafts that are press-fit into a central longitudinal passage 110 defined through the rotor 28. As will become appreciated herein, while typical rotor shafts extend through the entire rotor, the separate first and second rotor shafts 102 and 104 of the rotor shaft assembly 100 are separate and distinct. As a result, many advantages are realized. The split shaft design allows the press-fit diameters on the separate first and second rotor shafts 102, 104 to be decoupled. Because the shafts 102 and 104 are decoupled, “inching” and rotor “pop” can be eliminated. In another advantage, the mass of the supercharger can be reduced by incorporating two stub shafts instead of one continuous shaft.

The following discussion is directed toward the rotor shaft assembly 100 configured for supporting the rotor 28 and having the first and second rotor shafts 102, 104. It will be appreciated that another rotor shaft assembly having first and second press-fit stub shafts is provided for supporting the rotor 29. In this regard, the supercharger 26 will incorporate two pairs of stub shafts.

The first rotor shaft 102 can generally include a first insertion portion 120, an intermediate seal engaging portion 122, a front bearing engaging portion 124 and a timing gear attachment portion 128. Other configurations are contemplated. The intermediate seal engaging portion 122 transitions to the first insertion portion 120 at a first radial collar 130. In one configuration the intermediate seal engaging portion 122 can be heat treated. The gear attachment portion 128 can be used to couple a timing gear. The first radial collar 130 can engage the rotor 28 to assist in press-fitting the first rotor shaft 102 into the central longitudinal passage 110 of the rotor 28. The first insertion portion 120 can further incorporate a straight knurl feature 134 for additional torsional retention. The inner diameter of the central longitudinal passage 110 is sufficient to maintain retention of the first rotor shaft 102 at the first insertion portion 120. The first insertion portion 120 therefore is designed for retention of the rotor 28 onto the first rotor shaft 102. Moreover, because the central longitudinal passage 110 remains hollow (without a rotor shaft occupying the space), some of the stresses otherwise experienced at the rotor 28 from a continuous solid shaft are relieved.

The second rotor shaft 104 can generally include a second insertion portion 140 and a rear bearing engaging portion 142. The second rotor shaft 104 can include a second radial collar 146 that can be dimensioned to be nestingly received at a counterbore 150 defined in the rotor 28. The counterbore 150 can have an inner diameter that is greater than an inner diameter of the central longitudinal passage 110. The second insertion portion 140 can be configured to also be press-fit into the central passage 110. During thermal expansion, because the first and second rotor shafts 102 and 104 are separate and distinct, any growth of the rotor 28 will not encourage the press-fits of either of the first or second rotor shafts 102, 104 to decouple. The growth can generally occur in the center section of the rotor 28. In prior art examples, the rear interface of the rotor 28 and the continuous rotor shaft was such that relative movement of the rotor at the rear interface was permitted, influencing the “inching” described above. The instant design incorporating the separate shafts 102, 104 precludes such behavior.

In another advantage, when assembling a single rotor shaft onto a rotor according to prior art, the interaction at the front and rear rotor interface needs to be essentially simultaneous. In the instant configuration having separate shafts 102, 104, the press-fit sequence need not occur at the same time. Explained differently, the first shaft 102 can be press-fit into the longitudinal passage 110 and thereafter the second shaft 104 can be press-fit into the longitudinal passage 110 (or vise-versa).

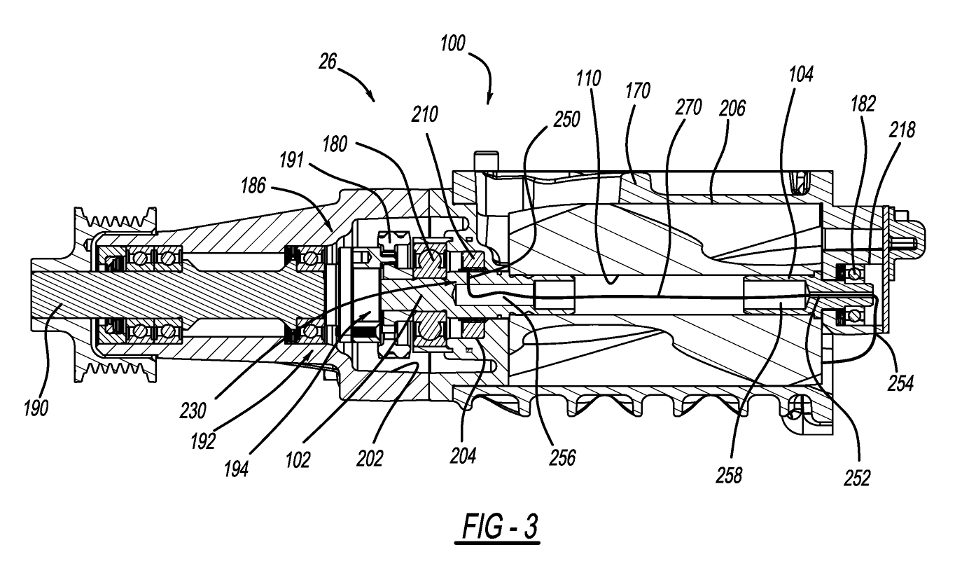

With additional reference now to FIG. 3, additional features of the supercharger 26 will be described. The supercharger 26 can have a housing 170 that defines the overlapping cylindrical chambers 28c and 29c. The first and second rotor shafts 102 and 104 are rotatably supported by the housing 170 at a front bearing 180 and a rear bearing 182.

An isolator or coupling assembly 186 couples an input shaft 190 to the first rotor shaft 102. In one example, a first hub 192 can couple the input shaft 190 to the isolator assembly 188 on a first end and a second hub 194 can couple the first rotor shaft 102 to the isolator assembly 186 on an opposite end. A first timing gear 191 may be mounted on a forward end of the rotor shaft 102. The first timing gear 191 may define teeth that are in meshed engagement with gear teeth of a second timing gear (not specifically shown) that is mounted on a rotor shaft assembly (not specifically shown) associated with the second rotor 29. The second rotor shaft assembly therefore would be in driving engagement with the blower rotor 29. It will be appreciated that the isolator assembly 186 shown in FIG. 3 is merely exemplary and other isolators may be used to couple the input shaft 190 and the first rotor shaft 102.

In one configuration, positive torque is transmitted from an internal combustion engine (of the periodic combustion type) to the input shaft 190 by any suitable drive means, such as a belt and pulley drive system. Torque is transmitted from the input shaft 190 to the rotor shaft assembly 100 through the isolator assembly 186. The isolator assembly 186 can provide torsional and axial damping and can further account for misalignment between the input shaft 190 and the first rotor shaft 102. When the engine is driving the timing gears and the blower rotors 28 and 29, such is considered to be transmission of positive torque. On the other hand, whenever the momentum of the rotors 28 and 29 overruns the input from the input shaft, such is considered to be the transmission of negative torque.

With continued reference to FIG. 3, additional features of the housing 170 will be described. The housing 170 can generally define a bearing cavity 202, a seal receiving cavity 204 and a rotor cavity 206. The bearing cavity 102 is positioned intermediate the isolator assembly 186 and the seal receiving cavity 204. The bearing cavity 102 houses the front bearing 180. The seal receiving cavity 204 houses a front rotor shaft seal 210. The rotor cavity 206 houses the rotors 28 and 29. The housing 170 can further define a rear bearing cavity 218 that houses the rear bearing 182.

Additional features of the supercharger 26 will now be described. The supercharger 26 incorporates a vent configuration 230. As will be explained further herein, the vent configuration 230 routes air that may escape from the rotor cavity 206 past the seal 210 back to the inlet passage 32 (FIG. 1) of the supercharger 26. In this regard, external leakage can be inhibited. In addition, additional cost associated with external tubing can be avoided. The vent configuration 230 includes (i) a first passage 250 defined in the first rotor shaft 102, (ii) a second passage 252 defined in the second rotor shaft 104, and (iii) a third passage 254 defined through the housing 170 proximate the rear bearing 182.

The first passage 250 connects an outer surface of the first rotor shaft 102 with an internal bore 256 of the first rotor shaft 102. The second passage 252 connects an outer surface of the second rotor shaft 104 with an internal bore 258 of the second rotor shaft 104. A flow path 270 can be realized through the first passage 250 of the first rotor shaft 102, through the internal bore 256, along the central longitudinal passage 110 of the rotor 28, through the internal bore 258 of the second rotor shaft 104, through the second passage 252, through the third passage 254 and toward the inlet passage 32 of the supercharger.

The first passage 250 can be a feeder hole that is cross-drilled into the first rotor shaft 102. The second passage 252 can be an exit hole that is drilled into the second rotor shaft 104. Other configurations are contemplated.

The foregoing description of the examples has been provided for purposes of illustration and description. It is not intended to be exhaustive or to limit the disclosure. Individual elements or features of a particular example are generally not limited to that particular example, but, where applicable, are interchangeable and can be used in a selected example, even if not specifically shown or described. The same may also be varied in many ways. Such variations are not to be regarded as a departure from the disclosure, and all such modifications are intended to be included within the scope of the disclosure.

What is claimed is:

1. A supercharger comprising:
a housing;
a first rotor and a second rotor received in cylindrical overlapping chambers of the housing, the first rotor having a central longitudinal passage; and
a rotor shaft assembly rotatably supporting the first rotor and including a first rotor shaft and a separate and distinct second rotor shaft, wherein the first and second rotor shafts are press-fit into the central longitudinal passage defined in the first rotor.

2. The supercharger of claim 1 wherein the first and second rotor shafts are stub shafts.

3. The supercharger of claim 1 wherein the first and second rotor shafts are offset from each other in the central longitudinal passage.

4. The supercharger of claim 1, further comprising:
a front bearing disposed in the housing that supports the first rotor shaft;
a rear bearing disposed in the housing that supports the second rotor shaft.

5. The supercharger of claim 4 wherein the first rotor shaft includes a first insertion portion that is received by the central longitudinal passage, an intermediate seal engaging portion configured to be engaged by a seal, a front bearing engaging portion that is supported by the front bearing, and an isolator engaging portion that is configured to engage a timing gear.

6. The supercharger of claim 5 wherein the second rotor shaft includes a second insertion portion that is received by the central longitudinal passage and a rear bearing engaging portion that is supported by the rear bearing.

7. The supercharger of claim 6 wherein the second rotor shaft includes a second radial collar that is dimensioned to be nestingly received at a counterbore defined in the first rotor.

8. The supercharger of claim 7 wherein the counterbore has a first inner diameter and the central longitudinal passage has a second inner diameter and wherein the first inner diameter is greater than the second inner diameter.

9. The supercharger of claim 5 wherein the first insertion portion incorporates a straight knurl feature.

10. The supercharger of claim 1, further comprising a vent configuration collectively formed by:
a first passage defined in the first rotor shaft;
a second passage defined in the second rotor shaft; and
a third passage defined through the housing, wherein air is routed through the vent configuration toward an inlet of the supercharger.

11. The supercharger of claim 10, further comprising a front rotor shaft seal that sealingly engages the first rotor shaft.

12. The supercharger of claim 10 wherein the first passage connects an outer surface of the first rotor shaft with an internal bore of the first rotor shaft.

13. The supercharger of claim 10 wherein the second passage connects an outer surface of the second rotor shaft with an internal bore of the second rotor shaft.

14. A supercharger comprising:
a housing;
a first rotor and a second rotor received in cylindrical overlapping chambers of the housing, the first rotor defining a central longitudinal passage; and
a rotor shaft assembly rotatably supporting the first rotor and comprising:
a first rotor shaft having a first insertion portion that is received by the central longitudinal passage, an intermediate seal engaging portion configured to be engaged by a seal, a front bearing engaging portion that is supported by the front bearing, and an isolator engaging portion that is configured to engage a timing gear; and
a second rotor shaft, separate and distinct from the first rotor shaft, the second rotor shaft having a second insertion portion that is received by the central longitudinal passage and a rear bearing engaging portion that is supported by the rear bearing.

15. The supercharger of claim 14 wherein the first and second rotor shafts are press-fit into the central longitudinal passage defined in the first rotor.

16. The supercharger of claim 15 wherein the counterbore has a first inner diameter and the central longitudinal passage has a second inner diameter and wherein the first inner diameter is greater than the second inner diameter.

17. The supercharger of claim 14, further comprising a vent configuration collectively formed by:
a first passage defined in the first rotor shaft;
a second passage defined in the second rotor shaft; and
a third passage defined through the housing, wherein air is routed through the vent configuration toward an inlet of the supercharger.

18. The supercharger of claim 17, further comprising a front rotor shaft seal that sealingly engages the first rotor shaft.

19. The supercharger of claim 17 wherein the first passage connects an outer surface of the first rotor shaft with an internal bore of the first rotor shaft.

20. The supercharger of claim 17 wherein the second passage connects an outer surface of the second rotor shaft with an internal bore of the second rotor shaft.
